(19) United States
(12) Patent Application Publication
(10) Pub. No.: US 2026/0005558 A1
(43) Pub. Date: Jan. 1, 2026

(54) STATOR FOR AN ELECTRIC MACHINE, ELECTRIC MACHINE, MOTOR VEHICLE AND METHOD FOR PRODUCING A STATOR

(71) Applicant: SCHAEFFLER TECHNOLOGIES AG & CO. KG, Herzogenaurach (DE)

(72) Inventors: Michael Bulatow, Berlin (DE); Marco Mechi, Rosignano Marittimo (LI) (IT); Astrid Haas, Falkensee (DE); Stephan Aurich, Neukirchen (DE); Markus Haugk, Wittgensdorf (DE); Wilhelm Hackmann, Berlin (DE)

(73) Assignee: SCHAEFFLER TECHNOLOGIES AG & CO. KG, Herzogenaurach (DE)

(21) Appl. No.: 18/868,452

(22) PCT Filed: Jun. 1, 2023
(86) PCT No.: PCT/EP2023/064644

§ 371 Date: Sep. 17, 2025

(30) Foreign Application Priority Data
Jun. 3, 2022 (DE) 10 2022 205 711.2

(51) Int. Cl. H02K 1/16; H02K 15/027

(52) U.S. Cl. CPC H02K 1/165; H02K 15/027; H02K 2215/00

(57) ABSTRACT

The invention relates to a stator (ST) for an electric machine (EM) of an at least partially electrically driven motor vehicle (KFZ), comprising

an annular yoke (JO) with an inner side (IS) oriented inward in the radial direction, and a stator tooth (SZ), which is positively connected to the yoke (JO) and has a tooth shank (ZS) and a tooth head (ZK) adjoining the tooth shank (ZS), characterized in that a connecting projection (VV) oriented inward in the radial direction is formed on the inner side (IS) of the yoke (JO), and a connecting recess (VA) is formed on an end face (SS) of the tooth shank (ZS) that is formed on a side facing away from the tooth head (ZK), and, to obtain the positive connection, the connecting projection (VV) engages at least partially and/or in some portion or portions in the connecting recess (VA).

The invention relates to a stator for an electric machine, wherein the stator has an annular yoke and at least one stator tooth. The stator tooth is positively connected to the yoke. Provision is made here for a connecting projection to be formed on an inner side of the annular yoke and for the stator tooth to have a corresponding connecting socket. The subject matter of the invention also includes an electric machine having the stator according to the invention. The subject matter of the invention also includes a motor vehicle comprising the electric machine according to the invention. The subject matter of the invention also includes a method for producing the stator according to the invention.

A stator for an electric machine is known in principle. It is furthermore known that this stator can have an annular yoke and that at least one stator tooth is positively connected to the yoke. In order to connect the stator tooth to the yoke, it is envisaged that a recess oriented outward in the radial direction is formed on an inner side of the yoke, which faces a stator axis. On an end face, the stator tooth itself has a projection, which engages in the corresponding recess in the yoke. The projection and the recess have a dovetail contour. DE 10 2012 022 868 A1 and also DE 10 2006 043 673 A1 show a stator designed in this way, for example.

The problem with the known stators is their production. If the yoke and the stator teeth are punched out of a sheet, the yoke is punched, on the one hand, and the stator teeth are punched next to it. Owing to the projection on the end face of the stator teeth, it is generally not possible to punch all the stator teeth of one row out of the inner sheet of the annular yoke. Thus, the sheet scrap and consequently also the costs for the stator are increased. Moreover, the separate punching of the yoke and the stator teeth from two different regions of the sheet may increase the thickness tolerance resulting from the manufacture of the sheets. In other words, the yoke and the stator tooth may have different sheet thicknesses in the region of connection. This inaccuracy may increase in the case of multiple successively arranged sheet layers of the yoke and the stator tooth.

It is an object of the invention to provide a stator for an electric machine which can be produced economically and can have a reduced thickness tolerance.

This object is achieved by means of the subject matter of the independent patent claims. Preferred developments of the invention are the subject of the dependent claims, the description which follows and the drawings. In this case, each feature may represent an aspect of the invention both individually and in combination, provided nothing to the contrary is explicitly stated in the description.

According to a first aspect, the invention relates to a stator for an electric machine of an at least partially electrically driven motor vehicle, comprising an annular yoke with an inner side oriented inward in the radial direction, and a stator tooth, which is positively connected to the yoke and has a tooth shank and a tooth head adjoining the tooth shank, characterized in that a connecting projection oriented inward in the radial direction is formed on the inner side of the yoke, and a connecting recess is formed on an end face of the tooth shank that is formed on a side facing away from the tooth head, and, to obtain the positive connection, the connecting projection engages at least partially and/or in some portion or portions in the connecting recess.

In other words, according to the first aspect of the invention, a stator for an electric machine is provided. The machine is preferably configured and/or designed to drive an at least partially electrically driven motor vehicle. In other words, the electric machine is mounted in the drive train of the motor vehicle.

The stator has an annular yoke, wherein the yoke has an inner side on a side oriented inward in the radial direction of the yoke. In addition, the stator has at least one stator tooth. Normally, the stator has a plurality of stator teeth. The stator tooth comprises a tooth shank and a tooth head adjoining the tooth shank. The tooth head is oriented inward in the radial direction of the yoke. The stator tooth is positively connected to the yoke. For this purpose, provision is made for a connecting projection oriented inward in the radial direction of the yoke to be formed on the inner side of the yoke. A connecting recess is formed on an end face of the tooth shank that is formed on a side facing away from the tooth head. In order to positively connect the stator tooth to the yoke, the stator tooth is inserted in the axial direction of the yoke in such a way that the connecting projection of the yoke engages at least in some portion or portions and/or partially in the connecting recess of the stator tooth.

On account of the fact that—contrary to the known prior art—the connecting projection is formed on the yoke, not on the stator tooth, it is possible, during a punching operation for punching the yoke and the stator tooth out of a sheet, to arrange the stator tooth adjacent to the connecting projection or between two connecting projections without weakening the yoke. Thus, the stator tooth or stator teeth can be punched out of an inner part of the sheet of the annular yoke. The production costs can thus be reduced since the sheet scrap is reduced. Moreover, the influence of the thickness tolerances resulting from the sheet can be reduced since the yoke and the stator tooth or stator teeth can be punched out of regions which are very close together.

One advantageous development of the invention consists in that the connecting projection has a shoulder, which projects inward in the radial direction, and a connecting lug. In other words, a projecting shoulder oriented inward in the radial direction is formed in the region of the connecting projection, starting from the inner side. Arranged on this shoulder there is, in turn, the connecting lug. Consequently, the inner side lies on an imaginary first circle. The shoulder lies on an imaginary second circle, the diameter of which is smaller than the diameter of the imaginary first circle. An outer side of the connecting lug, said side being oriented in the radial direction of the yoke, lies on an imaginary third circle, the diameter of which is smaller than the diameter of the imaginary second circle. The location of the center of the imaginary first circle is identical with the location of the center of the imaginary second circle, with the location of the imaginary third circle and with the location of the center of the annular yoke. Owing to the slightly recessed inner side, the stator tooth can be punched out between two adjacent connecting lugs, with the result that the end face of the tooth shank lies on the imaginary second circle, and a base of the connecting recess lies on the imaginary third circle.

Starting from the inner side of the yoke, the shoulder has a height in the radial direction of the yoke which is less than 2 mm, preferably less than 1 mm, and particularly preferably less than 0.5 mm, wherein the limits are inclusive.

Starting from the shoulder of the yoke, the connecting lug has a height in the radial direction of the yoke which is greater than 1 mm and less than 5 mm, preferably greater than 1.5 mm and less than 4 mm, and particularly preferably greater than 2 mm and less than 3 mm, wherein the limits are inclusive.

In one advantageous embodiment of the invention, it is envisaged that the end face of the tooth shank rests against the shoulder, and the connecting lug engages in the connecting recess. By virtue of the fact that the tooth shank rests on the shoulder of the yoke via the end face, it is possible to increase the rigidity of the positive attachment.

In principle, the positive connection can be designed in such a way that the stator tooth can be positively fastened and/or fixed on the yoke.

One preferred development of the invention consists in that the connecting lug is of dovetail design, and the connecting recess is of corresponding design to the connecting lug. In other words, the connecting recess is a negative to the dovetail-shaped connecting lug.

In one advantageous embodiment of the invention, it is envisaged that a transition between the end face and a side face of the tooth shank is of beveled or stepped design. The side face of the tooth shank extends between the end face as far as the tooth head. By virtue of the beveled and/or stepped transition between the end face and the side face of the pole tooth, it is possible—if a width of the tooth shank in the region of the end face is greater than a width of the inner side between two adjacent connecting projections—for the width of the tooth shank to be reduced in the region of the end face, thus enabling the stator tooth to be arranged between two mutually adjacent connecting projections for the purposes of the punching operation for punching the yoke and the stator tooth.

In principle, the stator can have just one stator tooth. One advantageous embodiment of the invention consists in that a plurality of stator teeth is provided, which are arranged spaced apart from one another in the circumferential direction of the yoke and are positively connected to the yoke.

It is conceivable for the tooth heads of two adjacent stator teeth to have a gap in the circumferential direction of the stator.

One advantageous development of the invention envisages that the respective tooth head of a stator tooth that is adjacent in the circumferential direction is interconnected by a connecting web.

It is conceivable for the connecting web to be inserted between the adjacent stator teeth. Thus, the connecting web can be formed from a different material than the stator tooth.

One advantageous development of the invention envisages that the connecting web is formed integrally with the tooth head. Consequently, the connecting web can be formed directly in the punching operation to form the stator teeth.

In a second aspect, the invention relates to an electric machine having the stator according to the invention.

The electric machine is configured and/or designed to drive an at least partially electrically driven motor vehicle.

In a third aspect, the invention relates to an at least partially electrically driven motor vehicle comprising the electric machine.

The electric machine is mounted in the drive train of the motor vehicle. It is part of a traction drive.

In a fourth aspect, the invention relates to a method for producing the stator according to the invention, wherein a sheet is provided, and the annular yoke is punched out in a first punching operation, and the at least one stator tooth is punched out in a second punching operation, wherein the stator tooth is punched out of the sheet in such a way that its end face faces the inner side of the yoke and is arranged adjacent to the yoke and/or offset with respect to the connecting projection and/or connecting lug in the circumferential direction of the yoke.

In other words, according to the fourth aspect of the invention, it is envisaged that at least one sheet is provided, from which the yoke and the at least one stator tooth are punched out. It is envisaged here that the annular yoke is punched out of the sheet in a first punching operation. The at least one stator tooth is punched out in a second punching operation. The yoke and the stator tooth are punched out of the sheet in such a way that the end face of the stator tooth faces the inner side of the yoke to be punched out or the negative contour of the punched-out yoke. In addition, the stator tooth is punched out of the sheet in a manner offset in the circumferential direction of the yoke with respect to the connecting projection and/or connecting lug of the yoke. A stator tooth axis running through the stator tooth preferably runs in the radial direction of the yoke or in the radial direction of the negative yoke contour punched out of the sheet.

On account of the fact that the connecting projection is formed on the yoke, not on the stator tooth, it is possible, during the punching operation for punching the yoke and the stator tooth out of a sheet, to arrange the stator tooth adjacent to the connecting projection and/or connecting lug without significantly weakening the yoke. Thus, the stator tooth or stator teeth can be punched out of an inner part of the sheet of the annular yoke. The production costs can thus be reduced since the sheet scrap is reduced. Moreover, the influence of the thickness tolerances resulting from the sheet can be reduced since the yoke and the stator tooth or stator teeth can be punched out of regions which are very close together.

Provision is advantageously made for the inner side of the yoke to lie on an imaginary first circle. The shoulder of the connecting projection lies on an imaginary second circle, the diameter of which is smaller than the diameter of the imaginary first circle. An outer side of the connecting lug, said side being aligned in the radial direction of the yoke, lies on an imaginary third circle, the diameter of which is smaller than the diameter of the imaginary second circle. This arrangement also applies to the negative yoke contour punched out of the sheet. On the sheet, the location of the stator tooth is provided in such a way that the end face of the tooth shank lies on the imaginary second circle, and a base of the connecting recess lies on the imaginary third circle. This has the advantage that the stator tooth or, in the case of a plurality of stator teeth, all the stator teeth can be punched out close to the respective connecting projection. The thickness tolerances are thus reduced. In addition, the sheet scrap can be reduced. This can have a positive effect on the production costs for the stator.

One preferred embodiment of the invention consists in that a plurality of first punching operations is carried out one after the other, wherein, after a first punching operation, a first punching tool and/or the sheet are rotated by a defined angle relative to one another before the next first punching operation is carried out. The yoke is punched out by means of the first punching operation. Consequently, a plurality of yokes is punched out and stacked one above the other or in series. The stacked sheets are preferably connected materially, positively and/or nonpositively to one another. The material connection can preferably be an adhesive connection. The positive connection can preferably be a stamped connection. The nonpositive connection can preferably be a connection by means of a screw anchor and/or tie rod.

In one preferred development of the invention, it is envisaged that a plurality of second punching operations is carried out one after the other, wherein, after a second punching operation, a second punching tool and/or the sheet are rotated by a defined angle relative to one another before the next punching operation is carried out. By means of the second punching operation, the stator tooth or the stator teeth of one layer are punched out. The individual layers of the stator teeth or of a stator tooth are arranged in series and connected materially and/or positively to one another. The positive connection is preferably accomplished by means of a stamped connection. The material connection is preferably an adhesive connection.

One preferred embodiment of the invention consists in that the first punching tool and the second punching tool are rotated by the same angle between two punching operations. In this way, the thickness tolerances of the sheet can be compensated for over the length of the stator in the axial direction thereof.

It is conceivable for the first punching tool and the second punching tool to be integral parts of one punching device.

It is conceivable for the first punching operation and the second punching operation to be carried out simultaneously or at the same time. Simultaneously preferably means that the beginning of the first punching operation starts with the beginning of the second punching operation and that the two punching operations also end together. At the same time means that either the first punching operation or the second punching operation starts and the respective other punching operation starts before the first or the second punching operation has ended.

However, it is also conceivable for the first punching operation and the second punching operation to be carried out one after the other or with a time offset.

In this context, it is conceivable for the first punching operation to be carried out first and the second punching operation to be carried out subsequently.

Alternatively and also preferably, it is envisaged that the second punching operation takes place before the first punching operation. In other words, the at least one stator tooth is punched out first. The yoke is then punched out. This has the advantage that both punching operations can be carried out with just a single fastening and/or fixing of the sheet outside the yoke.

It is pointed out that all features described above and below in reference to an aspect of the present invention apply equally to any other aspect of the present invention. In particular, all features of the stator may also be features of the electric machine and/or of the motor vehicle and/or of the method for producing the stator. This also applies conversely.

Further features and advantages of the present invention will emerge from the subclaims and the following exemplary embodiments. The exemplary embodiments are to be understood not as restrictive, but rather as examples. They are intended to enable a person skilled in the art to implement the invention. The applicant reserves the right to make one and/or more of the features disclosed in the exemplary embodiments the subject of patent claims or to include such features in existing patent claims. The exemplary embodiments will be discussed in more detail with reference to drawings,

in which:

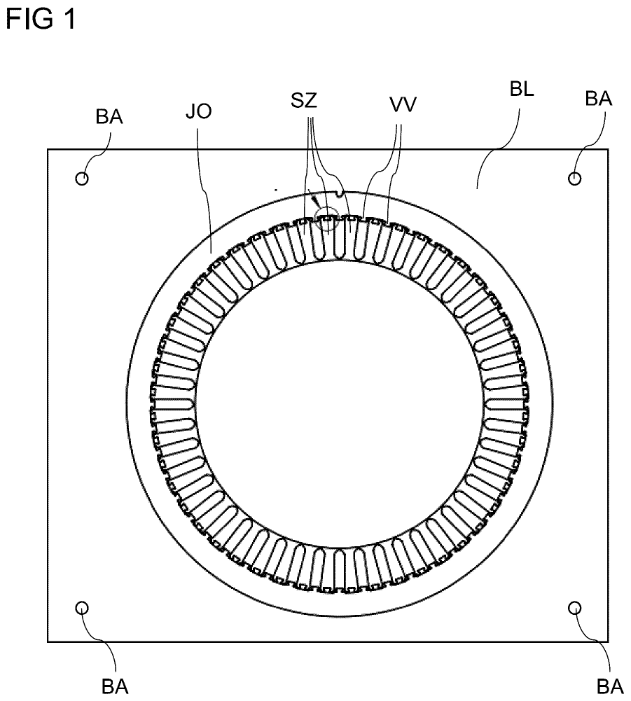

FIG. 1 shows a plan view of a sheet from which a layer of a yoke and a stator tooth can be punched,

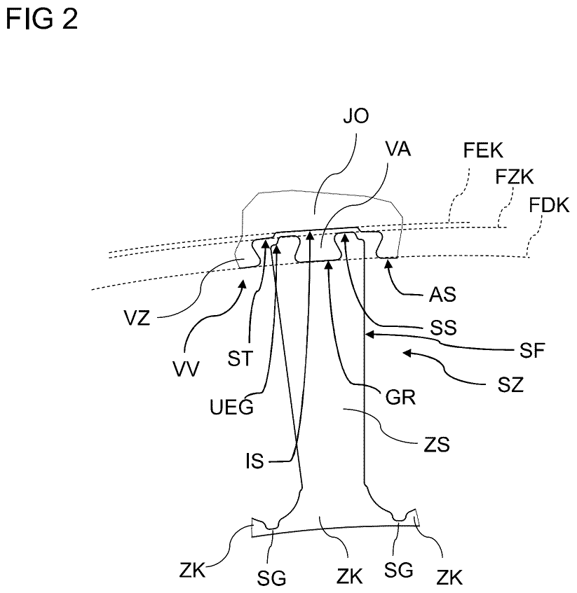

FIG. 2 shows a detail view of a punched stator tooth,

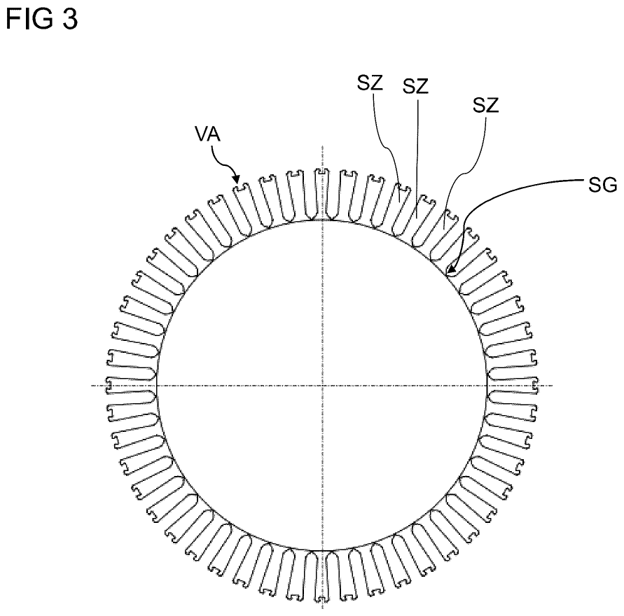

FIG. 3 shows a plan view of a layer of stator teeth, which are arranged spaced apart from one another in the circumferential direction,

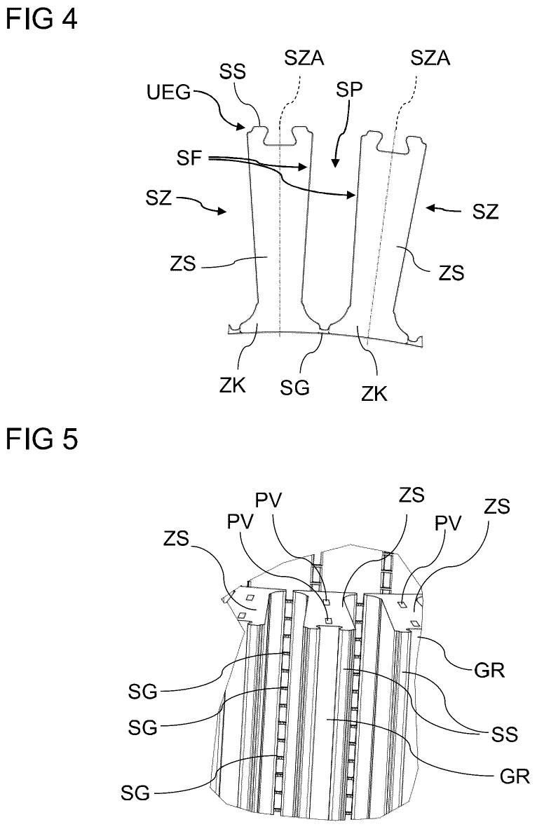

FIG. 4 shows a detail view of two stator teeth connected to one another by a connecting web,

FIG. 5 shows a cutout of the stator teeth in the longitudinal direction of the stator,

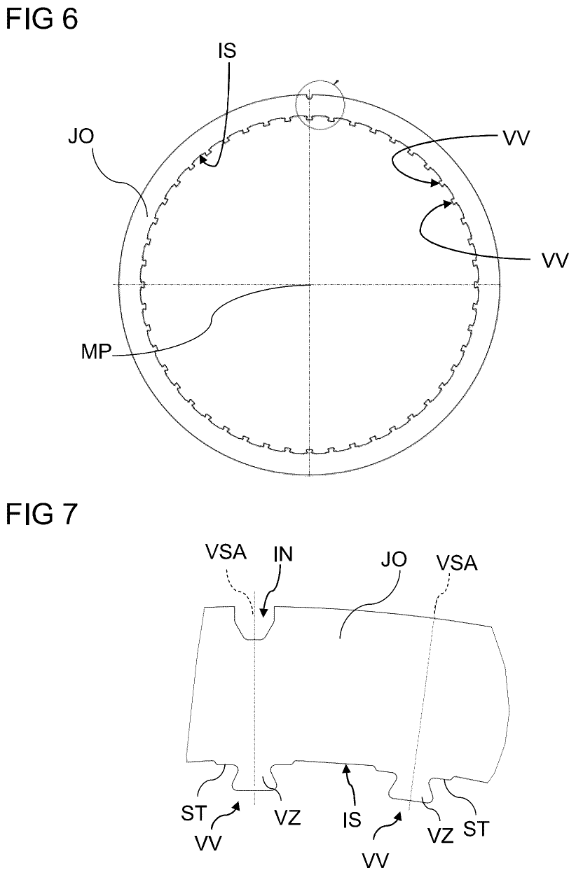

FIG. 6 shows a plan view of a punched yoke,

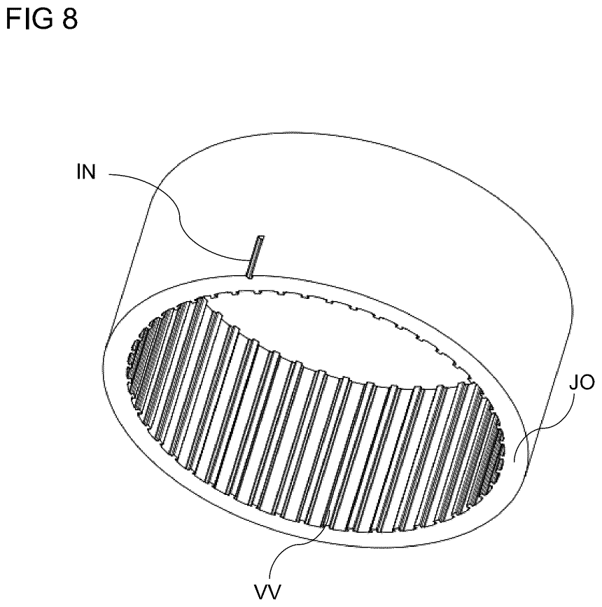

FIG. 7 shows a detail view of the yoke in the region of connecting projections,

FIG. 8 shows a three-dimensional view of the annular yoke,

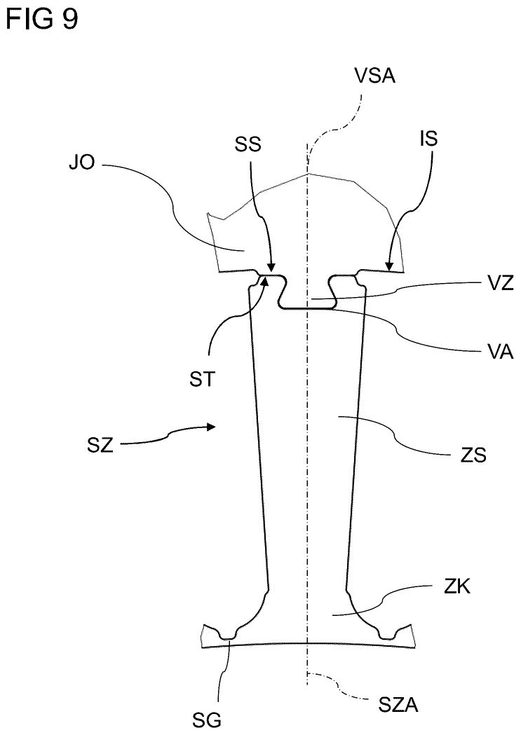

FIG. 9 shows a detail view of a stator tooth, which is connected to the yoke,

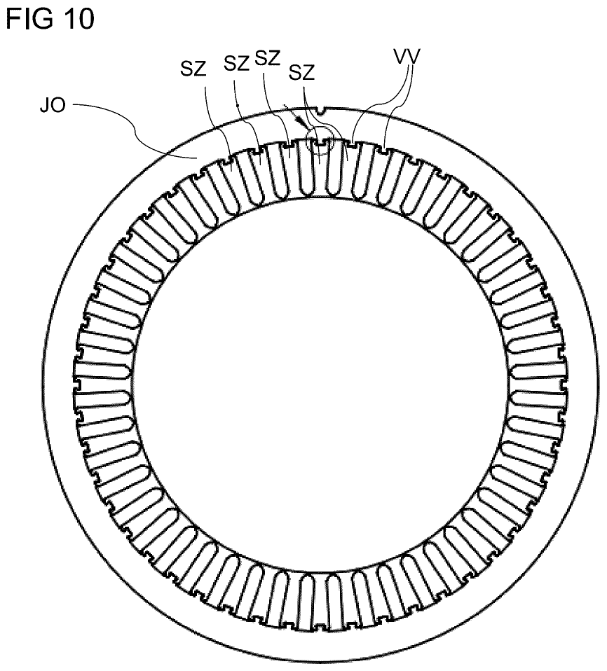

FIG. 10 shows a plan view of the stator, wherein a plurality of stator teeth is connected to the yoke,

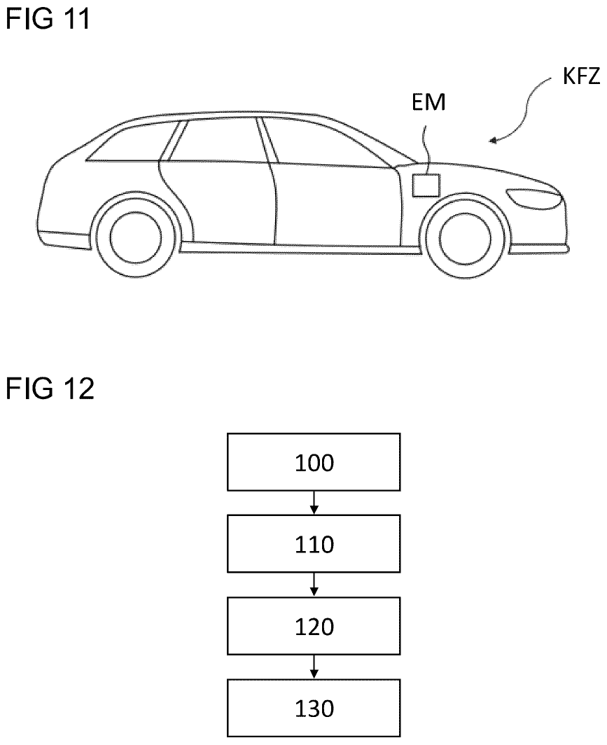

FIG. 11 shows a motor vehicle with an electric machine,

FIG. 12 shows a method for producing a stator.

FIG. 1 shows a plan view of a sheet BL, from which an annular yoke JO and at least one stator tooth SZ can be punched. The sheet BL can preferably be in the form of a strip. It is conceivable for the sheet BL to have at least one fastening and/or positioning aperture BA. The fastening aperture BA can preferably be a closed-edge aperture that penetrates the sheet. In the present case, the sheet BL has four mutually spaced fastening apertures BA. The fastening apertures BA are preferably used to position and/or fix the sheet BL in a punching device (not illustrated).

The contour of the annular yoke JO is shown on the sheet. The contour of the stator teeth SZ can also be seen. In total, 48 stator teeth SZ are arranged adjacent to one another in the circumferential direction of the yoke JO in the exemplary embodiment. The number of stator teeth SZ can vary, depending on the stator design.

FIG. 2 shows a detail view of a punched stator tooth SZ. A cutout of the annular yoke JO can also be seen. The yoke JO has an inner side IS on a side oriented inward in the radial direction of the yoke JO.

A plurality of connecting projections WV is formed on the inner side IS at regular intervals in the circumferential direction of the yoke JO. Only a certain portion of the connecting projections VV is shown in FIG. 2. Each connecting projection VV comprises a shoulder ST, which projects inward in the radial direction of the yoke JO, and a connecting lug VZ, which projects inward in the radial direction of the yoke JO.

The stator tooth SZ comprises a tooth shank ZS and a tooth head ZK adjoining the tooth shank. On a side facing away from the tooth head ZK, the tooth shank ZS has an end face SS. A connecting recess VA, which is oriented in the direction of the tooth head ZK and is of corresponding design to a contour of the connecting lug VZ, is formed on the end face SS of the tooth shank ZS. In other words, the connecting recess VA is a negative contour of the connecting lug VZ. In the present case, the connecting lug VZ and the connecting recess VA have a dovetail configuration.

The stator tooth SZ is punched out of the sheet BL in such a way that, at least in some portion or portions, the tooth shank ZS is arranged between two connecting projections VV adjacent to it in the circumferential direction of the yoke JO. The end face SS of the tooth shank ZS is oriented in the direction of the inner side IS of the yoke JO.

It can furthermore be seen that the inner side lies on an imaginary first circle FEK. The shoulder ST lies on an imaginary second circle FZK, the diameter of which is smaller than the diameter of the imaginary first circle FEK. An outer side AS of the connecting lug VZ, said side being oriented in the radial direction of the yoke JO, lies on an imaginary third circle FDK, the diameter of which is smaller than the diameter of the imaginary second circle FZK. It should be noted that the imaginary first circle, the imaginary second circle and the imaginary third circle each have the same center of the circle, and this center of the circle is simultaneously also the center of the circle of the yoke JO. Owing to the slightly recessed inner side IS, the stator tooth SZ can be punched out between two adjacent connecting lugs VZ, with the result that the end face SS of the tooth shank ZS lies on the imaginary second circle FZK, and a base GR of the connecting recess VA lies on the imaginary third circle FDK.

A transition UEG between the end face SS and a side face SF of the tooth shank ZS is of stepped design. The side face SF of the tooth shank ZS extends between the end face SS as far as the tooth head ZK. By virtue of the stepped transition UEG between the end face SS and the side face SF of the stator tooth SZ, it is possible—if a width of the tooth shank ZS in the region of the end face SS is greater than a width of the inner side IS between two adjacent connecting projections VV—for the width of the tooth shank ZS to be reduced locally in the region of the end face SS, thus enabling the stator tooth SZ to be arranged or punched out between two mutually adjacent connecting lugs VZ for the purposes of the punching operation for punching the yoke JO and the stator tooth SZ.

It is conceivable for the adjacent stator teeth SZ in one sheet layer to have an interruption in the region of the tooth head ZK. In the present case, the adjacent tooth heads are connected to one another by a connecting web SG.

FIG. 3 shows the plan view of a layer of a total of 48 stator teeth SZ, which are arranged spaced apart from one another in the circumferential direction, wherein the tooth heads ZK of adjacent stator teeth SZ are connected to one another by the connecting web SG.

FIG. 4 shows a detail view of two adjacent stator teeth SZ connected to one another by the connecting web SG. A stator tooth axis SZA runs through each stator tooth SZ. Starting from the end face SS or starting from the transition UEG, the tooth shank ZS is designed to taper in the direction of the tooth head ZK over its entire length. A gap SP between the side faces SF of two adjacent tooth shanks ZS has a constant width. This enables a stator winding (not illustrated) designed as a mat to be inserted into the gap SP between the stator teeth SZ from a side remote from the connecting web SG.

FIG. 5 shows a cutout of the stator teeth SZ in the longitudinal direction of the stator ST. A plurality of individual sheets BL of a stator tooth SZ is arranged in series in the longitudinal direction of the stator ST and connected to one another via a stamped connection PV. It can be seen that, in the case of some sheet layers, tooth heads ZK of adjacent stator teeth SZ are connected to one another by the connecting web SG and, in the case of other sheet layers, the connecting web SG is absent or the tooth heads ZK of adjacent stator teeth SZ are not connected to one another, i.e. are of web-free design.

FIG. 6 shows the yoke JO punched out in a ring shape, with the connecting projections VV formed on the inner side IS of the yoke JO in a manner spaced apart from one another in the circumferential direction of the yoke JO. The 48 connecting projections VV are spaced apart from one another at regular intervals. The center MP of the circle of the annular yoke JO is also shown.

FIG. 7 shows a detail view of the yoke JO in the region of two connecting projections VV arranged adjacent to one another. An index groove IN is formed on an outer side of the yoke JO, which is oriented outward in the radial direction of the yoke JO, to enable a clear selection or determination of the alignment of the yoke JO at a later point in time. Running through the connecting projection VV is a projection axis VSA, which runs in the radial direction of the yoke JO. The shoulder ST and the connecting lug VZ are formed in mirror symmetry with respect to the projection axis VSA.

FIG. 8 shows a three-dimensional view of the annular yoke JO with a plurality of yoke layers arranged in series. The individual layers are arranged in series in such a way that the connecting projections VV are in alignment in the longitudinal of the stator or yoke JO. In other words, the connecting projections VV extend parallel to the stator axis or yoke axis over the entire length of the stator. The individual yoke layers are connected to one another by means of a stamped connection or an adhesive connection.

FIG. 9 shows a detail view of a stator tooth SZ, which is positively connected to the yoke. The stator tooth SZ is slipped onto the connecting projection VV in the longitudinal direction of the yoke JO, such that the connecting lug VZ of the yoke JO engages in the connecting recess VA of the stator tooth SZ. The end face SS of the tooth shank ZS rests against the shoulder ST of the yoke JO. The projection axis VSA of the yoke JO is in alignment with the stator tooth axis SZA of the stator tooth SZ.

FIG. 10 shows a plan view of the stator ST, wherein a plurality of stator teeth SZ is positively connected to the yoke JO. Before the stator teeth SZ are connected to the yoke JO, a stator winding (not illustrated) is inserted into the gap SP between the tooth shanks ZS.

FIG. 11 shows an at least partially electrically driven motor vehicle KFZ with an electric machine EM that has the stator ST. The electric machine EM is mounted in the drive train of the motor vehicle KFZ. It is part of a traction drive.

FIG. 12 shows a method for producing a stator ST.

In a first step 100, a sheet BL is provided and fed to a punching device.

In a second step 110, the annular yoke JO is punched out by means of a first punching operation.

In a third step 120, the at least one stator tooth SZ is punched out by means of a second punching operation, wherein the stator tooth SZ is punched out of the sheet BL in such a way that its end face SS faces the inner side IS of the yoke JO and is arranged adjacent and/or offset with respect to the connecting projection VV and/or connecting lug VZ in the circumferential direction of the yoke JO.

In a fourth step 130, the yoke JO and the stator tooth SZ are positively connected.

On account of the fact that the connecting projection VV is formed on the yoke JO, not on the stator tooth SZ, it is possible, during the punching operation for punching the yoke JO and the stator tooth SZ out of the sheet BL, to arrange the stator tooth SZ adjacent to the connecting projection VV and/or connecting lug VZ without weakening the yoke. Thus, the stator tooth SZ or stator teeth SZ can be punched out of an inner part of the sheet of the annular yoke JO. The production costs for the stator ST can thus be reduced since the sheet scrap is reduced. Moreover, the influence of the thickness tolerances resulting from the sheet BL can be reduced since the yoke JO and the stator tooth SZ or stator teeth SZ can be punched out of regions which are very close together.

1. A stator (ST) for an electric machine (EM) of an at least partially electrically driven motor vehicle (KFZ), comprising
an annular yoke (JO) with an inner side (IS) oriented inward in the radial direction, and
a stator tooth (SZ), which is positively connected to the yoke (JO) and has a tooth shank (ZS) and a tooth head (ZK) adjoining the tooth shank (ZS), characterized in that
a connecting projection (VV) oriented inward in the radial direction is formed on the inner side (IS) of the yoke (JO), and
a connecting recess (VA) is formed on an end face (SS) of the tooth shank (ZS) that is formed on a side facing away from the tooth head (ZK), and,
to obtain the positive connection, the connecting projection (VV) engages at least partially and/or in some portion or portions in the connecting recess (VA).

2. The stator as claimed in claim 1, characterized in that the connecting projection (VV) has a shoulder (ST), which projects inward in the radial direction, and a connecting lug (VZ).

3. The stator as claimed in claim 2, characterized in that the end face (SS) of the tooth shank (ZS) rests against the shoulder (ST), and the connecting lug (VZ) engages in the connecting recess (VA).

4. The stator as claimed in claim 3, characterized in that the connecting lug (VZ) is of dovetail design, and the connecting recess (VA) is of corresponding design to the connecting lug (VZ).

5. The stator as claimed in one of the preceding claims, characterized in that a transition (UEG) between the end face (SS) and a side face (SF) of the pole tooth (PZ) is of beveled or stepped design.

6. The stator as claimed in one of the preceding claims, characterized in that a plurality of stator teeth (SZ) is provided, which are arranged spaced apart from one another in the circumferential direction of the yoke (JO) and are positively connected to the yoke (JO).

7. The stator as claimed in one of the preceding claims, characterized in that the respective tooth head (ZK) of a stator tooth (SZ) that is adjacent in the circumferential direction is interconnected by a connecting web (SG).

8. The stator as claimed in claim 7, characterized in that the connecting web (SG) is formed integrally with the tooth head (ZK).

9. A method for producing a stator (ST) as claimed in one of the preceding claims, characterized in that a sheet (BL) is provided, wherein
the annular yoke (JO) is punched out in a first punching operation, and
the at least one stator tooth (SZ) is punched out in a second punching operation, wherein the stator tooth (SZ) is punched out of the sheet (BL) in such a way that its end face (SS) faces the inner side (IS) of the yoke (JO) and is arranged adjacent and/or offset with respect to the connecting projection (VV) and/or connecting lug (VZ) in the circumferential direction of the yoke (JO).

10. The method as claimed in claim 9, characterized in that a plurality of first punching operations is carried out one after the other, wherein, after a first punching operation, a first punching tool and/or the sheet (BL) are rotated by a defined angle relative to one another before the next first punching operation is carried out.

11. The method as claimed in claim 9 or 10, characterized in that a plurality of second punching operations is carried out one after the other, wherein, after a second punching operation, a second punching tool and/or the sheet (BL) are rotated by a defined angle relative to one another before the next second punching operation is carried out.

12. The method as claimed in one of claims 9 to 11, characterized in that the first punching tool and the second punching tool are rotated by the same angle between two punching operations.

13. The method as claimed in one of claims 9 to 12, characterized in that the first punching operation and the second punching operation are carried out simultaneously or at the same time.

14. The method as claimed in one of claims 9 to 13, characterized in that the first punching operation and the second punching operation are carried out one after the other or with a time offset.

15. The method as claimed in claim 14, characterized in that the second punching operation takes place before the first punching operation.

16. An electric machine (EM) comprising a stator (ST) as claimed in one of claims 1 to 8.

17. A motor vehicle (KFZ) having an electric machine (EM) as claimed in claim 16.
